(19) United States
(12) Patent Application Publication
(10) Pub. No.: US 2025/0196062 A1
(43) Pub. Date: Jun. 19, 2025

(54) CERAMIC BASED HIGH-EFFICIENT CARBON DIOXIDE CAPTURING SYSTEM AND AN APPLICATION METHOD THEREOF

(71) Applicant: Chiuan Yun Precision Industry Co., Ltd., Hsinchu County (TW)

(72) Inventor: WEN-KUANG HSU, Hsinchu City (TW)

(21) Appl. No.: 18/545,000

(22) Filed: Dec. 19, 2023

(51) Int. Cl. B01D 53/62; B01D 53/82; B01J 20/04; B01J 20/30

(52) U.S. Cl. CPC B01D 53/62; B01D 53/82; B01J 20/041; B01J 20/3007; B01J 20/3021; B01J 20/3078; B01D 2257/504

(57) ABSTRACT

A ceramic based high-efficient carbon dioxide capture ceramic filtration system and an application method thereof, comprising: a carbon capturing exhaust pipe used to store a CO₂ capturing materials therein, wherein the CO₂ capturing materials mainly uses oyster shells as the main materials, combined with the porous structure and plasticity of clay. It constitutes a low-cost, high-efficient carbon dioxide capture filter material which has a lot of calcium oxide (CaO), that can be effectively triggered in a low-temperature working environment, convert calcium oxide into calcium hydroxide through the water vapor generated during combustion. At the same time, the carbon dioxide produced during combustion is captured. The overall application can achieve high-efficient carbon dioxide capture rate without the need to build other complex filtration devices, which can help reduce carbon emissions and achieve sustainable development of environmental protection.

### BACKGROUND OF THE INVENTION

### Field of the Invention

The present invention relates to the technical field of carbon dioxide (CO₂) emission reduction, particularly refers to a high-efficient CO₂ capturing by ceramic based system and an application method thereof.

### Background of the Invention

With development of industry and changes in human living habits, the CO₂ concentration in the atmosphere continues to rise. Research from the National Oceanic and Atmospheric Administration (NOAA) has pointed out that the increase in CO₂ concentration correlates positively with temperature increase of earth surface. This situation has caused problems such as collapse of ice sheets, climate change, and ecological crises. Therefore, a good carbon management strategy is essential.

In recent years, the CO₂ emissions in daily life have become an issue that cannot be ignored. In Taiwan, the CO₂ production by transportation and gas combustion takes up 25% of total emissions. Therefore, the government has announced, by 2050, the carbon emission from the residential sector must be included in net-zero emission policy. Among others, the direct capturing of CO₂ from combustion has become the subject of great interest in environmental protection community. While currently relies on absorptive method using ethanolamine as absorbent. Absorption technique, however, operates on the basis of large and complex facilities and is unable to deal with low CO₂ partial pressure emission. In addition, absorbents are of corrosive so equipment is oxidatively damaged over time.

Oyster shells are solid wastes and yet they are barely recycled. Therefore, the government needs to allocate additional budget for cleanup of oyster shells thus burdening environmental sustainability.

### SUMMARY OF THE INVENTION

In view of this, the main purpose of the present invention is to provide an application method of a high-efficient carbon dioxide capturing using ceramic based filtration system, which comprises:

Building a ceramic based high-efficient CO₂ capturing system which consists of a carbon capturing-exhaust pipe for capturing CO₂ therein, wherein the carbon capturing exhaust pipe has two opened ends, the first end is configured with an interface while the second end is configured with an air outlet, a ceramic based carbon capturing materials is placed in the central compartment between the first and second end of the carbon capturing exhaust pipe, wherein the following CO₂ capturing method is performed:
1, manufacture the CO₂ capturing materials, wherein powdered oyster shells and a clay are mixed and sintered into porous ceramics which contains a large amount of calcium oxide (CaO).
2, fill the CO₂ capturing materials in the central compartment of the carbon capturing exhaust pipe.
3, connect the carbon capturing exhaust pipe to an exhaust port of combustion heating equipment.
4, the water vapor (H₂O) known as by-products of combustion will chemically converts the CaO based ceramics into calcium hydroxide [(Ca(OH)₂] which in turn reacts with CO₂ to form calcium carbonate (CaCO₃) at the same time, namely, H₂O+CaO→Ca(OH)₂— and CO₂+Ca(OH)₂→CaCO₃₍ₛ₎+H₂O.

In a preferred embodiment, wherein the combustion heating equipment is a household water heater.

In a preferred embodiment, wherein the CO₂ capturing materials is of strip-shaped ceramics, granular ceramics, or cylindrical ceramics with air channels.

In a preferred embodiment, wherein the CO₂ capturing materials contains said clay and said powdered oyster shells in a ratio of 1:1, but it is not limited to foregoing description in practice.

Compared with the existing techniques, the advantage of the present invention is: wherein the CO₂ capturing materials uses oyster shells as the main component, combined with the porous clay. It constitutes a low-cost, high-efficient CO₂ capturing materials which contains a large quantity of calcium oxide (CaO) that can react with water vapor (H₂O) to form calcium hydroxide [Ca(OH)₂] which simultaneously captures CO₂ and reduces to calcium carbonate (CaCO₃). The overall application is simple and can achieve a high-efficient of CO₂ capture at low cost. This technique is suitable for many products such as household water heaters, automobile and motorcycle exhaust pipes, range hood exhaust pipes, and thermal power plants, which greatly reduce carbon emissions and achieve environmental sustainability.

### BRIEF DESCRIPTION OF THE DRAWINGS

FIG. 1 is a schematic diagram of carbon capturing exhaust pipe of the present invention.

FIG. 2 is an application example of carbon capturing exhaust pipe of the present invention.

FIG. 3A, FIG. 3B, FIG. 3C are schematic views of the CO₂ capturing materials of the present invention.

FIG. 4 is a flow chart of the application method of the present invention.

FIG. 5 is a processing procedure of the CO₂ capturing materials of the present invention.

FIG. 6 is the acidic value of the CO₂ capturing materials of the present invention.

FIG. 7 is CO₂ concentration recording of the present invention.

There are representative symbols shown in foregoing figures. Wherein, the ceramic based high-efficient CO₂ capturing system 100, carbon capturing exhaust pipe 10, interface 11, enlarged cover body 115, air outlet 12, extension bellow 125, central compartment—15, CO₂ capturing materials 20, powdered oyster shell 21, clay 22, combustion heating equipment 50, exhaust port 51.

### DETAILED DESCRIPTION OF PREFERRED EMBODIMENTS

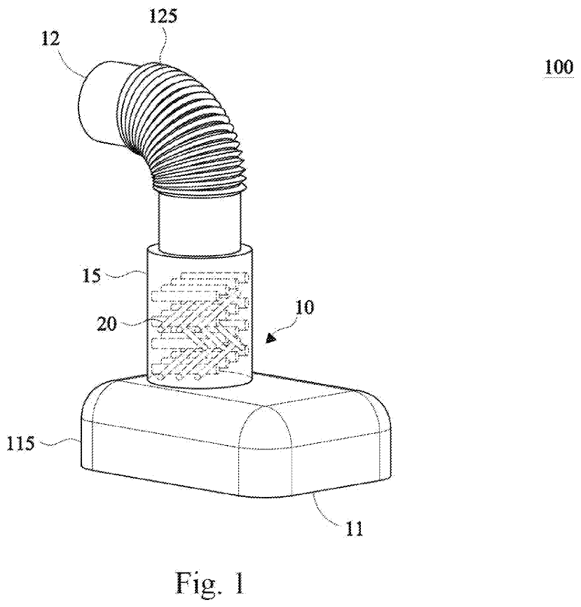

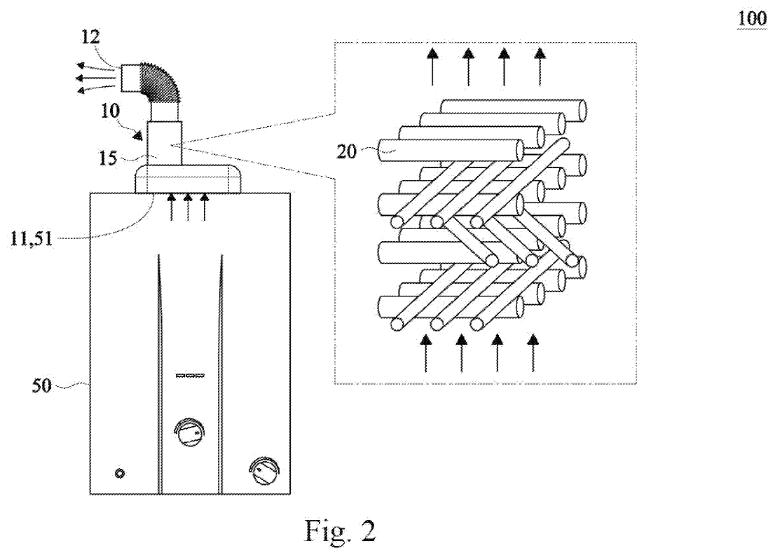

In order to understand the content of the present invention and the effects that can be achieved, specific embodiments are enumerated in conjunction with the drawings, and the detailed description is as follows: Please refer to FIG. 1 to FIG. 2, a ceramic based high-efficient CO₂ capturing system 100 which is provided by the present invention, mainly comprises:
A carbon capturing exhaust pipe 10 has two opened ends, the first end is configured with an interface 11 to be connected to an exhaust port 51 of a combustion heating equipment 50, and the second end is configured with an air outlet 12 to exhaust outside; and
A central compartment 15 is located between the first and the second end of the carbon capturing exhaust pipe 10, a CO₂ capturing materials 20 made from sintered powdered oyster shells 21 and porous clay 22 containing a large amount of calcium oxide (CaO).

In a preferred embodiment, wherein an enlarged cover 115 in front of the interface 11, and an extension bellow 125 is configured between the air outlet 12 and the central compartment 15, but the actual limitation is not limited to foregoing description.

In a preferred embodiment, the combustion heating equipment 50 is a household water heater, but it is not limited to foregoing description in practice. The present invention can be configured on the same principle to meet customized needs or for use with different equipment, such as automobile and motorcycle exhaust pipes, range hood exhaust pipes and thermal Power plants, etc. (not shown).

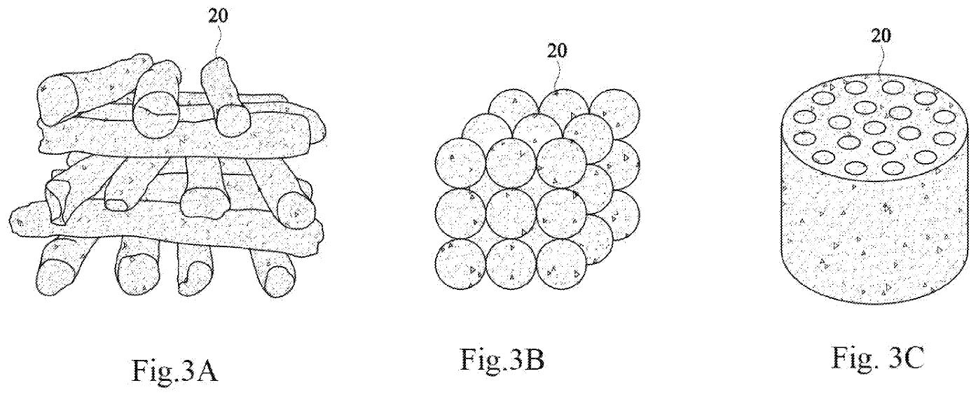

The preferred embodiment is as shown in FIG. 3A, FIG. 3B, and FIG. 3C, in which the CO₂ capturing materials 20 is ceramics with various shapes including strip-like, granular, or cylindrical with air channels, but this is not actually limited to foregoing description.

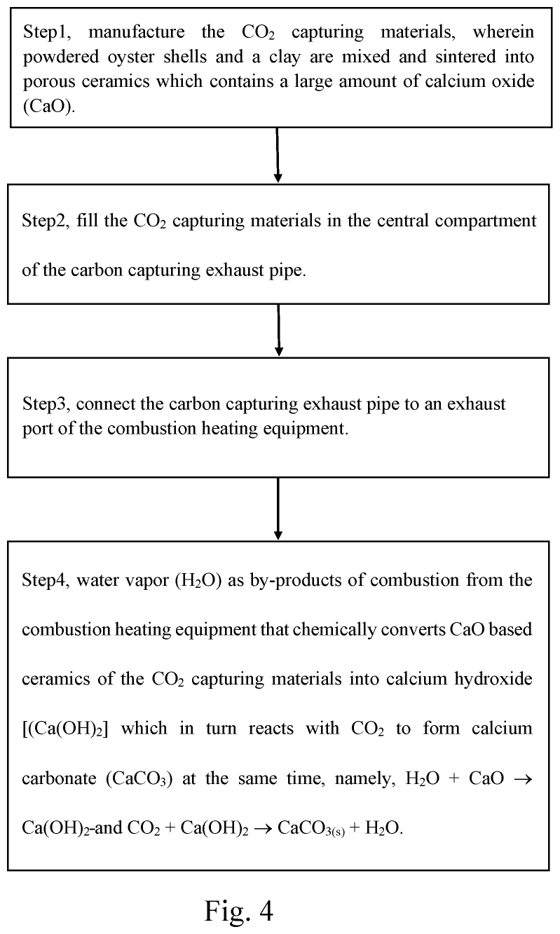

In a preferred embodiment, as shown in FIGS. 1 to 4, the application of ceramic based high-efficient CO₂ capturing system 100 of the present invention mainly comprises: a ceramic based high-efficient CO₂ capturing system 100 which consists of a CO₂ capturing ceramic materials 20 stored in an exhaust pipe 10, wherein the carbon capturing exhaust pipe 10 has two opened ends, the first end is configured with an interface 11, and the second end is configured with an air outlet 12, a central compartment 15 is located between the first and the second end of the carbon capturing exhaust pipe 10, wherein the CO₂ capturing materials 10 is present and the CO₂ capturing method is performed:
1, manufacture the CO₂ capturing materials 20, wherein powdered oyster shells 21 and a clay 22 are mixed and sintered into a porous structure which contains a large amount of calcium oxide (CaO) therein.
2, fill the CO₂ capturing materials 20 in the central compartment 15 of the carbon capturing exhaust pipe 10.
3, connect the carbon capturing exhaust pipe 10 to an exhaust port 51 of the combustion heating equipment 50. Wherein the interface 11 of the carbon capturing exhaust pipe 10 that is connected to an exhaust port 51 of the combustion heating equipment 50, the air outlet 12 of the carbon capturing exhaust pipe 10 is used to exhaust air outside.
4, water vapor (H₂O) as by-products of combustion from the combustion heating equipment 50 that chemically converts CaO based ceramics of the CO₂ capturing materials 20 into calcium hydroxide [(Ca(OH)₂] which in turn reacts with CO₂ to form calcium carbonate (CaCO₃) at the same time, namely, H₂O+CaO→Ca(OH)₂— and CO₂ +Ca(OH)₂→CaCO₃₍ₛ₎+H₂O.

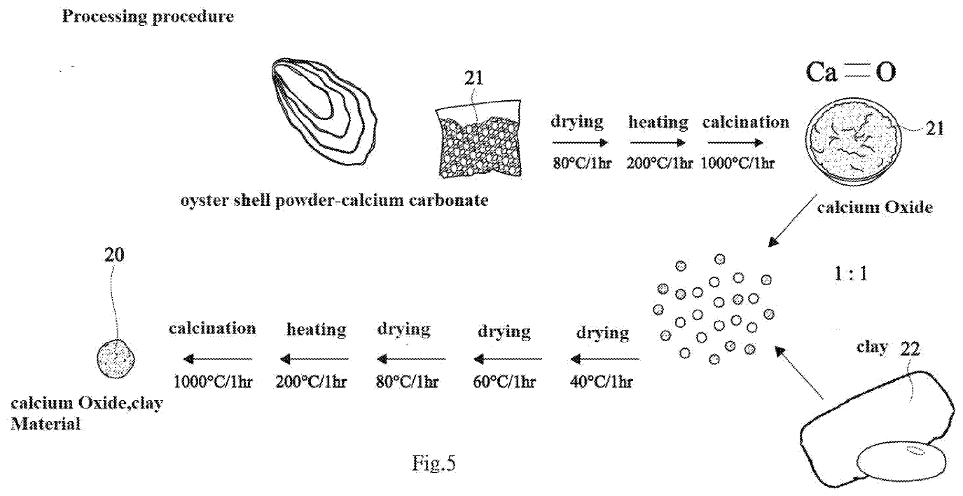

In a preferred embodiment, as shown in FIG. 5, the CO₂ capturing materials 20 contains said clay 22 and said powdered oyster shells 21 in a ratio of 1:1, but the actual ratio is not limited to this.

In a preferred embodiment, wherein the specific preparation method of the CO₂ capturing materials 20, which grind the powdered oyster shells 21 and then calcine the powdered oyster shells 21 through multiple stages of temperature increasing parameters, then cool down to room temperature by furnace cooling, the heat-treated powdered oyster shells 21 and the clay 22 are mixed with water, form a fixed shape: heat treatment with multi-stage temperature increasing parameters, cool down to room temperature by furnace cooling.

The detailed manufacturing process of the CO₂ capturing materials 20 of the present invention is as follows:

First, the used oyster shells are collected, washed thoroughly to remove residues and organisms, then dried and ground into powdered oyster shells 21 by using appropriate equipment.

In a preferred embodiment, wherein the CO₂ capturing materials 20 further grinds the powdered oyster shells 21, then calcination was carried out sequentially from 80° C. for 1 hour, 200° C. for 1 hour, 1000° C. for 1 hour with multi-stage temperature increasing parameters.

Select the clay 22 materials with good mixing condition, and then use an appropriate ratio such as 1:1, but it is not limited to this in practice. Mix the powdered oyster shells 21 into the clay 22 to ensure even dispersion.

In a preferred embodiment, wherein the CO₂ capturing materials 20 is further mixed with the heat-treated powdered oyster shells 21 and the clay 22 mixed with water: form a fixed shape: then sequentially heated at 40° C. 15 minutes to 1 hour, 60° C. 15 minutes to 1 hour, 80° C. 30 minutes to 1 hour, 200° C. for 1 hour, to 1000° C. for 1 hour with multi-stage temperature increasing parameters, so as to dry the clay 22 to remove moisture, then powdered oyster shells 21 and the clay 22 are sintered at high temperature: At the same time, the calcium carbonate (CaCO₃) in the main component of the powdered oyster shells 21 is converted into calcium oxide (CaO) after high temperature treatment, therefore that has carbon dioxide (CO₂) capturing efficiency.

The technical advantages of the CO₂ capturing materials 20 of the present invention:
1. The raw materials used in the present invention are clay 22 and powdered oyster shells 21, which have the advantages of low cost, high efficiency and “circular economy”.
2. The proportion of powdered oyster shells 21 can be appropriately increased, and the filter materials can be processed through heat treatment so that the internal water vapor can slowly diffuse to the surface, thereby shaping the shape of the filter materials without causing cracks in the filter materials.

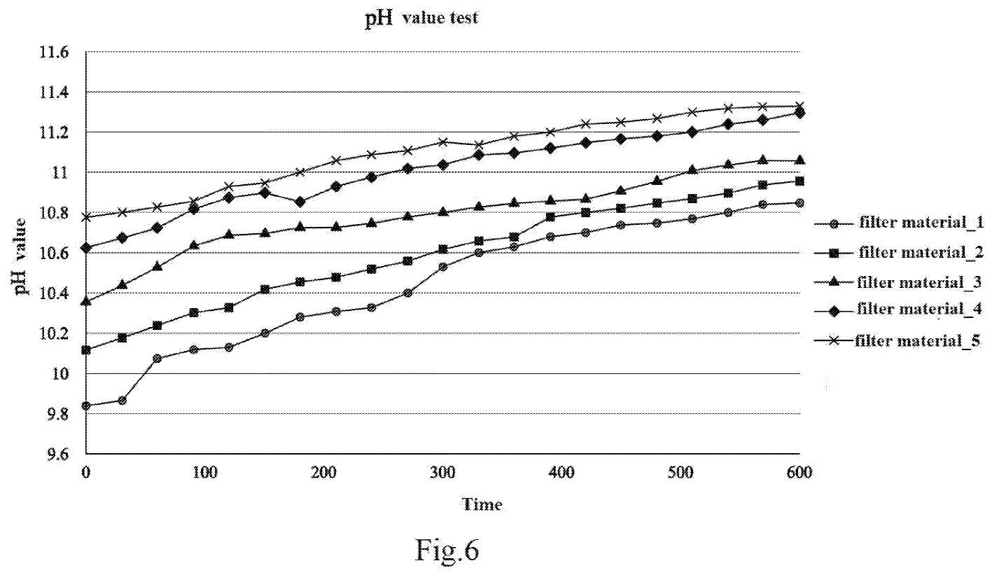

3. At room temperature, calcium oxide (CaO) can be converted into calcium hydroxide [Ca(OH)₂], which can achieve low-temperature triggering effects. As shown in FIG. 6, among them, from the filter material_1 to the filter material_5, respectively put 10 grams to 50 grams filter material of the CO₂ capturing materials 20 into 100 ml of deionized water to detect the pH value.

When used, as shown in FIG. 1, the CO₂ capturing materials 20 is shaped into a suitable size and is heat-treated to generate a strip-shaped ceramics or granular ceramics filter materials, which is filled interstitially among a central compartment 15 of the carbon capturing exhaust pipe 10. The carbon capturing exhaust pipe 10 is then installed on the household water heater, and the enlarged cover body 115 of the interface 11 is combined with the exhaust port 51 of the household water heater, and the air outlet 12 is used to exhaust the air outside. This can be easily completed installation, so that when the water vapor is released from the water heater, calcium oxide (CaO) can be converted into calcium hydroxide [Ca(OH)₂] at room temperature, which can achieve a low-temperature triggering effect and can be used to effectively capture the carbon dioxide (CO₂) produced during combustion and lock it in the CO₂ capturing materials 20, and the captured and converted exhaust gas can be exhausted outdoors through the air outlet 12.

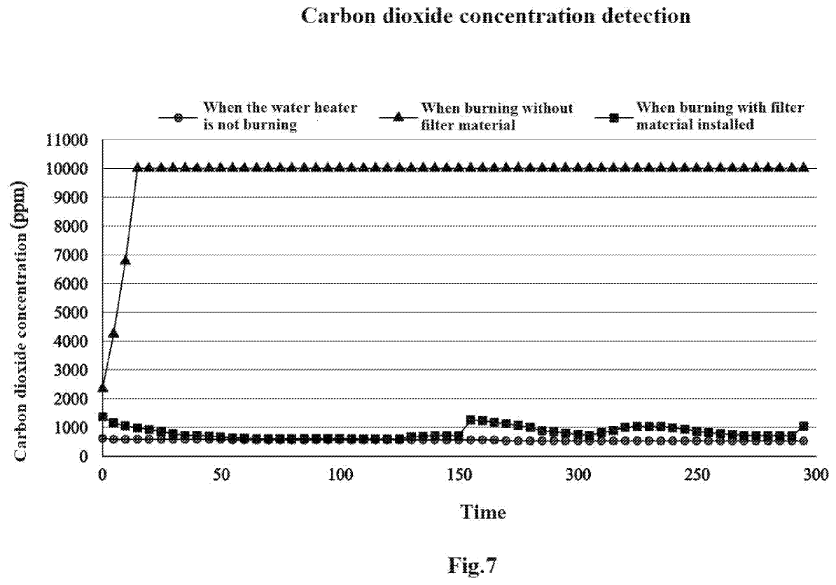

As shown in FIG. 7, the actual measured data of the system application of the present invention can prove that the carbon capturing exhaust pipe 10 installed on the water heater has a built-in CO₂ capturing materials 20, and the carbon dioxide (CO₂) emissions are measured when the water heater is used for combustion. It is found that the technology of the present invention can achieve a relatively high carbon dioxide capture rate (96.03%) at the working temperature of the general water heater exhaust pipe (65 to 80 degrees), that makes household water heater emissions more environmentally friendly. Really and effectively remove carbon dioxide (CO₂) and no longer burden the atmosphere.

The system operation of the present invention is very simple and does not require complex control or special skills. It can be easily assembled into household water heaters and requires no additional special maintenance in daily operation. Ideal for general promotion to all households. The system has high carbon dioxide (CO₂) capture efficiency, which can not only reduce carbon emissions but also convert it into useful substances. After the CO₂ capturing materials 20 is used, it can also be converted into calcium oxide (CaO) and carbon dioxide (CO₂) through heat treatment. This process can be recycled to enable long-term carbon dioxide (CO₂) capture and recovery. The recovered carbon dioxide (CO₂) can be used in carbon recycling technologies to convert it into useful chemicals and fuels such as synthetic fuels, methanol and ethylene to reduce reliance on fossil fuels. Or used in sparkling drinks and carbonated foods in the beverage and food industry, or used to adjust the pH value of water to improve water quality, or even for other medical purposes or rocket power.

Compared with the prior art technology, the practical advantage of the system of the present invention is that the CO₂ capturing materials 20 mainly adopts powdered oyster shells 21 as the main material, which is combined with the porous structure and plasticity characteristics of the clay 22. It constitutes a low-cost, high-efficient CO₂ capturing materials that is rich in calcium oxide (CaO), thereby solving environmental problems in ports, carbon dioxide (CO₂) emissions in people's livelihood, and promoting carbon management. The product is excellent and can be effectively triggered in low-temperature working environments. Through the water vapor produced during combustion, calcium oxide (CO₂) is converted into calcium hydroxide [Ca(OH)₂], and the carbon dioxide (CO₂) produced during combustion is captured at the same time. The overall application does not require the construction of additional complex filtering devices to achieve high-efficient carbon dioxide capture rates. This technology is not only suitable for general household water heaters, but can also be widely used in different categories, such as in automobile and motorcycle exhaust pipes, range hood exhaust pipes, and thermal power plants, which can help reduce carbon emissions and achieve sustainable development of environmental protection.

In summary, the invention is novel and practical and fully meets the patent requirements, and the present invention patent application is filed. However, the foregoing descriptions are only preferred embodiments of the present invention, and should not be used to limit the scope of the present invention. Therefore, all equivalent changes and modifications made based on the patent scope of the present invention and the content of the present invention specification shall be within the scope covered by the patent of this invention.

What is claimed is:

1. A ceramic based high-efficient carbon dioxide capturing system, comprising:
a carbon capturing exhaust pipe has two opened ends, a first end is configured with an interface to be connected to an exhaust port of a combustion heating equipment, and a second end is configured with an air outlet to exhaust outside; and
a central compartment is located between the first and the second end of the carbon capturing exhaust pipe, the CO₂ capturing materials made from sintered powdered oyster shells and porous clay containing a large amount of calcium oxide (CaO).

2. The ceramic based high-efficient carbon dioxide capturing system as claimed in claim 1, wherein the combustion heating equipment is a household water heater, the CO₂ capturing materials is configured with strip-shaped ceramics, granular ceramics, or cylindrical ceramics with air channels.

3. The ceramic based high-efficient carbon dioxide capturing system as claimed in claim 1, wherein an enlarged cover in front of the interface, and an extension bellow is configured between the air outlet and the central compartment.

4. An application method of a ceramic based high-efficient carbon dioxide capturing system, which comprises: building a ceramic based high-efficient CO₂ capturing system which consists of a carbon capturing exhaust pipe for capturing CO₂ therein, wherein the carbon capturing exhaust pipe has two opened ends, a first end is configured with an interface while the second end is configured with an air outlet, a ceramic based carbon capturing materials is placed in the central compartment between the first and second end of the carbon capturing exhaust pipe, wherein the following CO₂ capturing method is performed:
a) manufacturing the CO₂ capturing materials, wherein powdered oyster shells and a clay are mixed and sintered into porous ceramics which contains a large amount of calcium oxide (CaO);
b) filling the CO₂ capturing materials in the central compartment of the carbon capturing exhaust pipe;
c) connecting the carbon capturing exhaust pipe to an exhaust port of the combustion heating equipment; and
d) water vapor (H₂O) as by-products of combustion from the combustion heating equipment that chemically converts CaO based ceramics of the CO₂ capturing materials into calcium hydroxide [(Ca(OH)₂] which in turn reacts with CO₂ to form calcium carbonate (CaCO₃) at the same time, namely, H₂O+CaO→Ca(OH)₂— and CO₂+Ca(OH)₂→CaCO₃₍ₛ₎+H₂O.

5. The application method of the ceramic based high-efficient carbon dioxide capturing system as claimed in claim 4, wherein the combustion heating equipment is a household water heater.

6. The application method of the ceramic based high-efficient carbon dioxide capturing system as claimed in claim 4, wherein the CO₂ capturing materials is of strip-shaped ceramics, granular ceramics, or cylindrical ceramics with air channels.

7. The application method of the ceramic based high-efficient carbon dioxide capturing system as claimed in claim 4, wherein the CO₂ capturing materials contains said clay and said powdered oyster shells in a ratio of 1:1.

8. The application method of the ceramic based high-efficient carbon dioxide capturing system as claimed in claim 7, wherein the further specific preparation method of the CO₂ capturing materials comprises:
grinding the powdered oyster shells and then calcine the powdered oyster shells through multiple stages of temperature increasing parameters;
cooling down to room temperature by furnace cooling;
the heat-treated powdered shell powder and the clay being mixed with water;
form a fixed shape;
heat treatment with multi-stage temperature increasing parameters; and
cooling down to room temperature by furnace cooling.

9. The application method of the ceramic based high-efficient carbon dioxide capturing system as claimed in claim 8, wherein the CO₂ capturing materials further grinds the powdered shell powder, then calcination was carried out sequentially from 80° C. for 1 hour, 200° C. for 1 hour, 1000° C. for 1 hour with multi-stage temperature increasing parameters.

10. The application method of the ceramic based high-efficient carbon dioxide capturing system as claimed in claim 8, wherein the CO₂ capturing materials is further mixed with the heat-treated powdered shell powder and the clay mixed with water; form a fixed shape; and
then sequentially heated at 40° C. for 15minutes to 1 hour, 60° C. 15 minutes to 1 hour, 80° C. 30 minutes to 1 hour, 200° C. for 1 hour, to 1000° C. for 1 hour with multi-stage temperature increasing parameters.
